(19) United States
(12) Patent Application Publication
(10) Pub. No.: US 2024/0098428 A1
(43) Pub. Date: Mar. 21, 2024

(54) METHOD FOR OPERATING A HEARING SYSTEM AND HEARING SYSTEM

(71) Applicant: Sivantos Pte. Ltd., Singapore (SG)

(72) Inventor: Homayoun Kamkar-Parsi, Erlangen (DE)

(21) Appl. No.: 18/519,324

(22) Filed: Nov. 27, 2023

Related U.S. Application Data
(63) Continuation of application No. PCT/EP2021/063892, filed on May 25, 2021.

(51) Int. Cl. H04R 25/00

(52) U.S. Cl. CPC H04R 25/405; H04R 25/552; H04S 2420/01

(57) ABSTRACT

A hearing system includes first and second hearing devices. A first reference signal and a first auxiliary signal are generated for the first hearing device from an ambient sound by a first reference microphone and a first auxiliary microphone, respectively. A first pre-processed signal is generated by direction-sensitive pre-processing the reference and auxiliary signals. The first pre-processed signal shows a maximal attenuation for a generic sound signal originating from an angular range of [+90°, +270°] with respect to a first frontal direction, and a first head-related transfer function for the first hearing device is provided. A second pre-processed signal is generated for the second hearing device by its microphones which is representative of the ambient sound, and a second position-related transfer function is provided for the second hearing device. The pre-processed signals are subjected to a direction-sensitive signal processing task using the first and second head-related transfer functions.

### CROSS-REFERENCE TO RELATED APPLICATION

This application is a continuation, under 35 U.S.C. § 120, of copending International Patent Application PCT/EP2021/063892, filed May 25, 2021, which designated the United States; the prior application is herewith incorporated by reference in its entirety.

### FIELD AND BACKGROUND OF THE INVENTION

The invention pertains to a method for operating a hearing system which includes at least a first hearing device and a second hearing device, the first hearing device comprising at least a first reference microphone and a first auxiliary microphone, and the second hearing device comprising at least a number of microphones. A first reference signal and a first auxiliary signal are generated for the first hearing device from an ambient sound by the first reference microphone and the first auxiliary microphone, respectively, and a first pre-processed signal is generated by applying a direction-sensitive pre-processing to the first reference and auxiliary signals. A second pre-processed signal is generated for the second hearing device, said second pre-processed signal being representative of said ambient sound, by means of said number of microphones, and wherein a direction-sensitive signal processing task is performed on the first pre-processed signal and the second pre-processed signal.

In many applications of binaural hearing systems with two hearing devices, a directional signal processing task is implemented by some type of directional pre-processing for each hearing device, and using the pre-processed signals for finally performing the desired direction-dependent signal processing task. For example, blocking matrices may be generated from the microphone signals of the microphones in the hearing devices, using different combinations of the microphones of the full microphone array consisting of all of the hearing system's microphones, and the information of the different blocking matrices may be used for direction-dependent noise reduction or source localization.

This in particular holds for those binaural hearing systems in which each of the hearing devices comprises at least two or even more microphones. In such a case, very often, local pre-processing is applied to the several microphone signals obtained from an ambient, i.e., environment sound for each hearing device. For example, a single hearing device of the binaural hearing system may comprise two microphones, and the resulting to microphone signals are being locally pre-processed by some direction-dependent algorithm, to generate a local signal which already may show some noise reduction or other kind of enhancement (e.g., by attenuating signals from the back hemisphere of the user of the system). A direction-dependent signal processing task, such as source localization or beamforming, may then be performed by using the corresponding local pre-processed signals from each side.

For a direction-dependent pre-processing of these microphone signals, the relative positions and the resulting level differences and sound delays for the involved microphones have to be taken into account, as well as the position of the microphones with respect to the user's head. This can be done via a head-related transfer function (HRTF) for each microphone, which represents the propagation of a generic sound signal from a certain spatial direction towards the corresponding microphone and also takes into account shadowing effects coming from the head and/or the pinna of the user. However, in case that an overall direction-dependent signal processing task shall also be implemented by use of one or more HRTFs, the local pre-processing may introduce certain inaccuracy with respect to the transfer function that is to be used for the global directional processing.

Published patent application US 2011/0293108 A1 discloses a system and method of producing a directional output signal is described including the steps of: detecting sounds at the left and right sides of a person's head to produce left and right signals; determining the similarity of the signals; modifying the signals based on their similarity; and combining the modified left and right signals to produce an output signal. The generation of the left and right signals may employ the use of respective head-related transfer functions.

Published patent application US 2013/0136271 A1 discloses a method for determining a noise reference signal for noise compensation and/or noise reduction. A first audio signal on a first signal path and a second audio signal on a second signal path are received. The first audio signal is filtered using a first adaptive filter to obtain a first filtered audio signal. The second audio signal is filtered using a second adaptive filter to obtain a second filtered audio signal. The first and the second filtered audio signal are combined to obtain the noise reference signal. The first and the second adaptive filter are configured to minimize a wanted signal component in the noise reference signal.

### SUMMARY OF THE INVENTION

It is an object of the invention to provide a method of operating a hearing system which overcomes a variety of disadvantages of the heretofore-known devices and methods of this general type and which provides for a method for operating a hearing system, which allows for a direction-dependent local pre-processing of the signals of the hearing system's individual devices without distorting the performance of a global direction-dependent signal processing using the output signals of the hearing device for the global processing. It is furthermore an object of the invention to provide a hearing system comprising certain hearing devices, which allows for a local pre-processing in said hearing devices prior to a global, direction-dependent signal processing based on signals generated from the local pre-processing in each hearing device with as little spatial distortion as possible.

With the above and other objects in view there is provided, in accordance with the invention, a method of operating a hearing system, the hearing system including a first hearing device and a second hearing device, the first hearing device having a first reference microphone and a first auxiliary microphone, and the second hearing device having a number of microphones, the method comprising:
for the first hearing device:
   generating a first reference signal and a first auxiliary signal from an ambient sound by the first reference microphone and the first auxiliary microphone, respectively;
   defining a first frontal direction as a direction from the first auxiliary microphone towards the first reference microphone; and
   generating a first pre-processed signal by applying a direction-sensitive pre-processing to the first reference signal and the auxiliary signal by way of corresponding first reference and first auxiliary pre-processing coefficients, respectively, to be chosen and applied to the first reference signal and the first auxiliary signal accordingly in such a way that the first pre-processed signal shows a maximal attenuation for a generic sound signal originating from an angle that is restricted to an angular range of [+90°, +270°] with respect to the first frontal direction;
   providing a first head-related transfer function that is representative of a propagation of a generic sound signal from a given angle towards the first hearing device when the first hearing device is mounted on a head of a user;
for the second hearing device:
   generating a second pre-processed signal by way of the number of microphones, the second pre-processed signal being representative of the ambient sound; and
   providing a second position-related transfer function, representative of the propagation of the generic sound signal from a given angle towards the second hearing device when the second hearing device is mounted at a specific location; and
   performing a direction-sensitive signal processing task on the first pre-processed signal and the second pre-processed signal, using the first head-related transfer function and the second position-related transfer function; and
wherein the first pre-processed signal is generated by way of an adaptive beamforming process employing the first reference and first auxiliary pre-processing coefficients.

In other words, the first above-mentioned object is achieved by a method for operating a hearing system, in which a first reference signal and a first auxiliary signal are generated for the first hearing device from an environment sound by the first reference microphone and the first auxiliary microphone, respectively, and a first pre-processed signal is generated by applying an adaptive beamforming process as a direction-sensitive pre-processing to the first reference and auxiliary signals employing corresponding first reference and first auxiliary pre-processing coefficients, respectively, and wherein for the second hearing device, a second pre-processed signal is generated by means of said number of microphones, said second pre-processed signal being representative of said environment sound, and a second position-related transfer function is provided, representative of the propagation of a generic sound signal from a given angle towards the second hearing device when the second hearing device is mounted at a specific location, in particular, on the user's body.

According to the method, a first frontal direction is defined as the direction from the first auxiliary microphone towards the first reference microphone, and said first reference and auxiliary coefficients are chosen and accordingly applied to the first reference signal and the first auxiliary signal in such a way that said first pre-processed signal shows a maximal attenuation for a generic sound signal originating from an angle that is restricted to an angular range of [+90°, +270°], preferably of [+105°, +255°] and most preferably of [+125°, +235°], with respect to the first frontal direction as a result of said direction-sensitive pre-processing, and a first head-related transfer function is provided, said first head-related transfer function being representative of the propagation of a generic sound signal from a given angle towards the first hearing device when the first hearing device is mounted on the head of said user, wherein a direction-sensitive signal processing task is performed on the first pre-processed signal and the second pre-processed signal, using the first head-related transfer function and the second position-related transfer functions for said task. Embodiments of particular advantage, which may be inventive in their own right, are outlined in the dependent claims and in the following description.

According to the invention, the second above-mentioned object is achieved by a hearing system, comprising a first hearing device with at least a first reference microphone and a first auxiliary microphone, and a second hearing device with at least a number of microphones, the hearing system further comprising a control unit with at least one signal processor, wherein the hearing system is configured to perform the method for operating as outlined above and explained in detail in the following.

The hearing system according to the invention shares the advantages of the method for operating a hearing system according to the invention. Particular features of the method and of its embodiments may be transferred, in an analogous way, to the hearing system and its embodiments, and vice versa. In an embodiment, the hearing system may be configured as a binaural hearing system, wherein the first hearing device and said second hearing device are configured to be worn by a user on and/or at different ears during operation of the binaural hearing system.

Generally, a hearing system is understood as any system which provides an output signal that can be perceived as an auditory signal by a user or contributes to providing such an output signal. In particular, the hearing system may have means adapted to compensate for an individual hearing loss of the user or contribute to compensating for the hearing loss of the user. The hearing devices in particular may be given as hearing aids that can be worn on the body or on the head, in particular on or in the ear, or that can be fully or partially implanted. The hearing system may comprise other types of hearing devices, such as ear-buds. In particular, a device whose main aim is not to compensate for a hearing loss, for example a consumer electronic device (mobile phones, MP3 players, so-called “hearables” etc.), may also be considered a hearing system.

Within the present context, a hearing device can be understood as a small, battery-powered, microelectronic device designed to be worn behind or in or elsewhere at the human ear or at or on another body part by a user. A hearing device in the sense of the invention comprises a battery, a microelectronic circuit with a signal processor, and the specified number of microphones. A microphone shall be understood as any form of acousto-electric input transducer configured to generate an electric signal from an ambient sound. The signal processor is preferably a digital signal processor.

In particular, the first hearing device is a hearing device to be worn by the user on and/or at one of his ears during operation of the hearing system and in particular providing an output sound signal to the respective hearing of the ear. According to variations, the first hearing device need not comprise a traditional loudspeaker as output transducer. Examples that do not comprise a traditional loudspeaker are typically found in the field of hearing aids in the stricter sense, i.e., hearing devices designed and configured to correct for a hearing impairment of the user, and output transducers may be also be given by cochlear implants, implantable middle ear hearing devices (IMEHD), bone-anchored hearing aids (BAHA) and various other electro-mechanical transducer-based solutions including, e.g., systems based on using a laser diode for directly inducing vibration of the eardrum. However, a hearing aid may also comprise a traditional loudspeaker as output transducer.

The second hearing device may be configured as a hearing device to be worn by the user at or in the other ear (than the first hearing device), and may comprise an acoustic output transducer as described for the case of the first hearing device. Thus, the hearing system, in particular, may be given by a binaural hearing system with two hearing devices, configured to be worn by the user on and/or at different ears during operation.

The first hearing device and the second hearing device, however, may also be given by different types of devices, wherein the second hearing device may be given as an additional or auxiliary device of the hearing system not necessarily located at the other ear, but, e.g., worn around the neck, or on a wrist. The second hearing device, thus, need not be a hearing device with an output transducer of its own, but may be a device that, using its microphone(s), provides one or more input signals for signal processing, such that a resulting signal from said signal processing using also the signals generated from the second hearing device, is reproduced to the hearing of the user by the output transducer of the first hearing aid.

Apart from the first reference microphone and the first auxiliary microphone, the first hearing device may also comprise one or even more further microphones, each of which configured to generate a respective signal from the environment sound. Preferably, the second hearing device comprises an equal number of microphones as the first hearing device, however, this is not a necessary condition for operation of the hearing system according to the method. Preferably, during operation, the first and second hearing device are located noticeably apart from each other. In particular, each microphone of the hearing system may have an omni-directional characteristic.

The first reference microphone may in particular be given by a front microphone and the first auxiliary microphone by a back microphone of the first hearing device, i.e., due to the positioning of the first hearing device for operation of the hearing system, the first reference microphone is located before the first auxiliary microphone with respect to a frontal direction of the first hearing device.

Preferably, the first pre-processed signal is generated from the first reference signal and the first auxiliary signal by applying the first reference pre-processing coefficient to the first reference signal, and the first auxiliary pre-processing coefficient to the first auxiliary signal, preferably as multiplications in each case. Thus, the first reference signal in particular may be generated as a weighted sum of the first reference and auxiliary signal, weighted by the first reference and auxiliary pre-processing coefficients.

In particular cases, one of the first reference or auxiliary pre-processing coefficient may be trivial in the sense that it may be set to unity up to a global gain and/or phase factor shared with the respective other pre-processing coefficient.

As a part of the direction-sensitive pre-processing for generating the first pre-processing signal, the first reference and auxiliary pre-processing coefficients are determined by imposing the spatial condition onto the resulting first pre-processed signal that the angle at which the first pre-processed signal shows a maximal attenuation, i.e., the angle at which any impinging probe sound signal would get attenuated the most when varying the angle of the probe sound source, falls into the angular range of [+90°, +270°], and preferably [+105°, +255°], most preferably [+125°, +235°], with respect to the first frontal direction.

In particular, this means that the first frontal direction is defined as a direction of preference for the first hearing device, giving a spatial reference for the surrounding of the first hearing device. The angular range is then preferably understood in terms of a vector with an origin in the first hearing device and an angle from the mentioned range of [+90°, +270°], preferably of [+105°, +255°] and most preferably [+125°, +235°], with respect to the first frontal direction, i.e., an angular range of ±90° (preferably of ±75° and most preferably of ±55°), around the 180° or first backward direction (opposite to the first frontal direction). here, the assumption is made that the size of the first hearing device, and thus, possible differences in the choice of the origin of said vector, are negligible in comparison to the distance of the sound source.

In this respect, the first pre-processed signal may in particular be a beamformer signal, wherein a frequency-dependent phase factor may be implemented in at least one of the first reference or auxiliary pre-processing coefficients in time-frequency domain. In particular, either of the first reference and auxiliary pre-processing coefficients in time-frequency domain may be given by a spectral amplitude and said phase factor in time-frequency domain. The direction-sensitive pre-processing in general may be implemented in any way, and in particular comprises any linear combination of the first reference and auxiliary pre-processing signal—with possibly frequency-dependent linear coefficients (the first and second pre-processing coefficients)—that may result in a non-trivial directional characteristic of the first pre-processed signal, and thus, leads to a maximum for the attenuation at some angle. This maximum attenuation angle, according to the method, shall be restricted to the indicated angular range. The direction-sensitive pre-processing implementation may be given by sum-and-delay beamforming, differential microphones arrays (differential beamforming), delay-and-subtract beamforming, linear constraints minimum variance beamforming, minimum variance distortionless response beamforming, among others.

Particularly, the first pre-processed signal may be generated such that its directional characteristic shows a cardioid shape or a figure-of-eight shape or any smooth transitional shape between these cases, such as a hyper-cardioid shape or a super-cardioid shape, which preferably may be described as a convex combination of a cardioid shape and a figure-of-eight shape (or in an equivalent formulation, for instance, as a linear combination of a cardioid shape and an anti-cardioid shape, as long as the spatial constraints on the angle of maximal attenuation are fulfilled, which in this case may translate to a constraint for the respective linear factor). However, the direction-sensitive pre-processing shall not be limited to these cases, but may also contain other shapes for directional characteristics, as long as the angle of maximal attenuation for the directional characteristic, according to the method, falls into the angular range of [+90°, +270°] (i.e., the back hemisphere), and preferably [+105°, +255°], most preferably [+125°, +235°], with respect to the first frontal direction.

The second pre-processed signal is generated by means of the number of microphones of the second hearing device in the sense that the second hearing device may comprise only one microphone, and the respective microphone signal, generated from the environment sound by said microphone of the second hearing device is then also used as the second pre-processed signal, or may receive single-channel pre-processing, such as frequency dependent amplification for generating the second pre-processed signal.

However, the second hearing device may also comprise more than one microphone. In particular, the second pre-processed signal may be generated in a similar way as the first pre-processed signal, i.e., the second hearing device may comprise a second reference microphone and a second auxiliary microphone, each of which generating a respective signals from the environment sound which are being applied to a direction-sensitive pre-processing by means of corresponding pre-processing coefficients, just as in the case for the first pre-processed signal and its generation from the first reference and auxiliary signal. In particular, the second pre-processed signal is being representative of the environment sound, in the sense that it contains signal contributions from one or more signals directly generated by a microphone from the environment sound.

By means of the first head-related transfer function, in particular, propagation time differences (that may cause phase differences in time-frequency domain) between the hearing devices may be taken into account (by a respective phase factor in the first head-related transfer function with respect to a global phase frame or to the second position-related transfer function), as well as other possible differences in the propagation from the generic sound source located at said given angle towards one or another hearing device, in particular, the shadowing by the head (and possibly the pinna) of the user affecting the first reference and auxiliary microphone when the first hearing device is mounted properly for operation on the user's head, possibly causing also level differences.

The second position-related transfer function may also be given by a head-related transfer function, in case the second hearing device is configured to be worn by the user at or on his head. In case that the second hearing device is configured for a different position on the user's body, e.g., worn at the chest using a strap around the neck, or worn at the wrist, the second position-related transfer function has to be adapted accordingly, in particular with respect to the shadowing effects (and possible phase and level differences in case of two or more microphones in the second device) that may occur at this position.

The direction-sensitive signal processing task may be any possible task using at least two input signals generated at different locations, and preferably also respective transfer functions for each location, which processes and/or extracts any kind of spatial acoustic information encoded in these at least two input signals. In particular, said task may be given by the generation of the output signal using signal contributions of the first and second pre-processed signal, in particular by a weighted sum of said pre-processed signals, where in the weighting coefficients are given by the first head-related transfer function and second position-related transfer function, respectively. The direction-sensitive signal processing task may, however, also be given by a control operation in the sense that a control signal or, more generally, a control information is obtained, such as the location of a dominant sound source, or similar control operations.

The restriction of the angular range for a maximal attenuation, i.e., for a “minimal” direction or even a null direction, of the first pre-processed signal, possible spatial inaccuracies due to the direction-sensitive pre-processing in the first hearing device which might lead to the distortion of spatial information, can be reduced. This is particularly true for the case that the direction-sensitive signal processing task, which uses the first and second pre-processed signal, operates in the frontal hemisphere (with respect to the first frontal direction), i.e., in an angular range of ±90° around the first frontal direction, e.g., by localizing a sound source in the frontal hemisphere, or by generating a beamformer signal directed towards a sound source in the frontal hemisphere. Local pre-processing in the first hearing device is then essentially restricted to the complementary space, i.e., to the back hemisphere.

Preferably, said number of microphones of the second hearing device comprises at least a second reference microphone and a second auxiliary microphone, wherein for the second hearing device, a second reference signal and a second auxiliary signal are generated from said environment sound by the second reference microphone and the second auxiliary microphone, respectively, a second frontal direction is defined as the direction from the second auxiliary microphone towards the second reference microphone, and said second pre-processed signal is generated by applying a direction-sensitive pre-processing to the second reference and second auxiliary signal by means of corresponding second reference and second auxiliary pre-processing coefficients, respectively, to be accordingly chosen and applied to the second reference signal and the second auxiliary signal in such a way that said second pre-processed signal shows a maximal attenuation for a generic sound signal originating from an angle that is restricted to an angular range of [+90°, +270°], preferably of [+125°, +235°], with respect to the second frontal direction. One of the two hearing devices is to be worn by the user on or at his left ear during operation of the hearing system, while the other hearing device is to be worn on or at his right ear.

In this vein, the local pre-processing in the first and second hearing device can be performed by similar or even the same algorithms. However, the second pre-processed signal may differ from the first pre-processed signal even in case of equal pre-processing algorithms due to the mentioned head shadowing effects. These differences are then also reflected by the corresponding first and second head-related transfer functions.

In an embodiment, as said second position-related transfer function, a second head-related transfer function is provided, said second head-related transfer function being representative of a generic sound signal from a given angle towards the second hearing device when second hearing device is mounted on the head of said user, the first and second hearing device being mounted on different sides of the head. This means that for the case that the two hearing devices are to be mounted at the right and left side of the user's head (this shall not establish any correspondence which device to be mounted on which side), as the second position-related transfer function, a second head-related transfer function with similar properties as the first head-related transfer function is used.

In an embodiment, as said direction-sensitive signal processing task, an angle of a sound source is determined and/or a beamformer signal is generated, said beamformer signal containing signal contributions from the first and second pre-processed signal. For these tasks, the method shows particular advantages in that the spatial distortion is minimized by matching the first head-related transfer function to the corresponding first pre-processed signal. Advantageously, for determining said angle of a sound source, a set of spatial filters is generated by means of said first and second head-related transfer functions, each of said spatial filters forming an attenuation notch in space towards a different angle. For a source localization with said filters, using the first—and possibly the second—head-related transfer function generated according to the method from the respective local pre-processing coefficients, yields a particularly high accuracy.

The first pre-processed signal is generated by means of an adaptive beamforming process employing said first reference and first auxiliary pre-processing coefficients. In particular, the first reference signal and the first auxiliary signal may be used to derive two respective intermediate basis signals, such as a forward cardioid and a backward cardioid signal (sometimes referred to as an anti-cardioid), and the adaptive beamforming may be performed by using said intermediate basis signals. The first reference and first auxiliary pre-processing coefficients may then be derived from the respective coefficients for the intermediate basis signals obtained via the adaptive beamforming, and by the respective relations for the first reference and auxiliary signal in the intermediate basis signals.

In an embodiment, as said first head-related transfer function, a first reference head-related transfer function or a first auxiliary head-related transfer function is provided, being representative of the propagation of a generic sound signal from a given angle towards the first reference microphone or towards the first auxiliary microphone, respectively, when located at a respective position on the head of said user. The first reference microphone and the first auxiliary microphone, e.g., may be given as the respective front and rear microphone of the first hearing device, wherein the front/rear label is assigned according to the position of each microphone when the hearing device is worn as intended and provisioned for normal operation.

For a given hearing device, a relative transfer function of a specific microphone of the hearing device is particularly easy to measure, as the measurement may be done by using the corresponding microphone signal without any further input from other microphones.

The first pre-processed signal generated via a beamformer (i.e., resulting from the direction sensitive pre-processing) has an angular restriction in the back hemisphere in order not to affect (i.e., not to distort “too much”) the first head-related transfer function. As a consequence, the direction-sensitive signal processing task can still be successfully performed. Furthermore, the first head-related transfer function can be then approximated by the first reference head-related transfer function.

Similar considerations may hold for the second hearing device. In particular, as said second head-related transfer function, a second reference head-related transfer function or a second auxiliary head-related transfer function is provided, being representative of the propagation of a generic sound signal from a given angle towards the second reference microphone or towards the second auxiliary microphone, respectively, when located at a respective position on the head of said user.

Other features which are considered as characteristic for the invention are set forth in the appended claims.

Although the invention is illustrated and described herein as embodied in a method for operating a hearing system and a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic block diagram of a binaural hearing system;

FIG. 2 shows a schematic top view of a user of the binaural hearing system of FIG. 1 in an environment with different sound sources;

FIG. 3 shows polar plot diagrams of directional characteristics for a locally pre-processed signal of the binaural hearing system of FIG. 1;

FIG. 4 shows a polar plot diagram for restricting the angular range of the null direction of the directional characteristics shown in FIG. 3; and

FIG. 5 shows a schematic block diagram of a method for operating the binaural hearing system to FIG. 1 in the environment shown in FIG. 2 by means of the restrictions shown in FIG. 3.

Parts and variables corresponding to one another are provided with the same reference numerals throughout the figures.

### DETAILED DESCRIPTION OF THE INVENTION

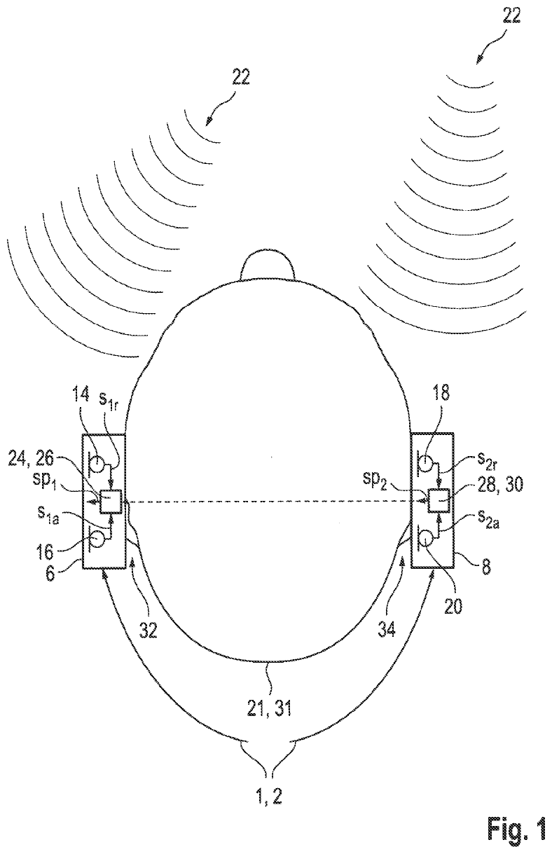

Referring now to the figures of the drawing in detail and first, in particular, to FIG. 1 thereof, there is shown a schematic block diagram for the signal flow in a hearing system 1. The hearing system 1 is a binaural hearing system 2 which comprises a first hearing device 6 and a second hearing device 8. However, in different embodiments, the second hearing device 8 might also be given by some other type of external device. The binaural hearing system 2 in an embodiment may also comprise an external control device, though such an external control device is optional. The first hearing device 6 comprises a first reference microphone 14 and a first auxiliary microphone 16, the second hearing device 8 comprises a second reference microphone 18 and a second auxiliary microphone 20.

The first reference microphone 14 may be a front microphone and the first auxiliary microphone 16 may be a back microphone of the first hearing device 6, i.e., during normal operation of the hearing system 1, due to the positioning of the first hearing device 6 for operation, the first reference microphone 14 is located in front of the first auxiliary microphone 16 with respect to a forward direction. A similar arrangement may apply to the second reference and auxiliary microphones 18, 20 in the second hearing device 8.

Each of the mentioned microphones has an a priori omni-directional characteristic in the sense that the microphones are configured and designed to have an equal sensitivity for all directions. In a way not shown in detail, the first hearing device 6 further comprises a control unit with at least one signal processor, and an output transducer for converting an output signal into an output sound that it presented to the hearing of a user 21 of the binaural hearing system 12. Likewise, the second hearing device 8 may also comprise a similar control unit and an output transducer.

An ambient sound 22, i.e., and environment sound 22, is converted into a first reference signal sir by the first reference microphone 14, into a first auxiliary signal s₁ₐ by the first auxiliary microphone 16, into a second reference signal s₂ᵣ by the second reference microphone 18, and into a second auxiliary signal as to a by the second auxiliary microphone 20. In a way yet to be described, a direction-sensitive pre-processing 24 is applied to the first reference signal sir and the first auxiliary signal s₁ₐ, and as a result, a first pre-processed signal sp₁ is generated. The direction-sensitive pre-processing in the present case is given by a first local beamformer 26. In a similar way, a direction-sensitive pre-processing 28, given by a second local beamformer 30, is applied to the second reference signal s₂ᵣ and the second auxiliary signal s₂ₐ, and as a result, a second pre-processed signal sp₂ is generated. The second pre-processed signal sp₂ is transmitted to the first hearing device 6 in order to perform said direction-sensitive signal processing task.

For operation of the binaural hearing system 2, the user 21 is wearing the binaural hearing system 12 on his head 31, i.e., he is wearing the first hearing device 6 on the left side 32 of his head 31, on or at his left ear, and the second hearing device 8 on the right side 34 of his head 31, on or at his right ear. Obviously, the assignment of first and second hearing device to left and right ear may be interchanged.

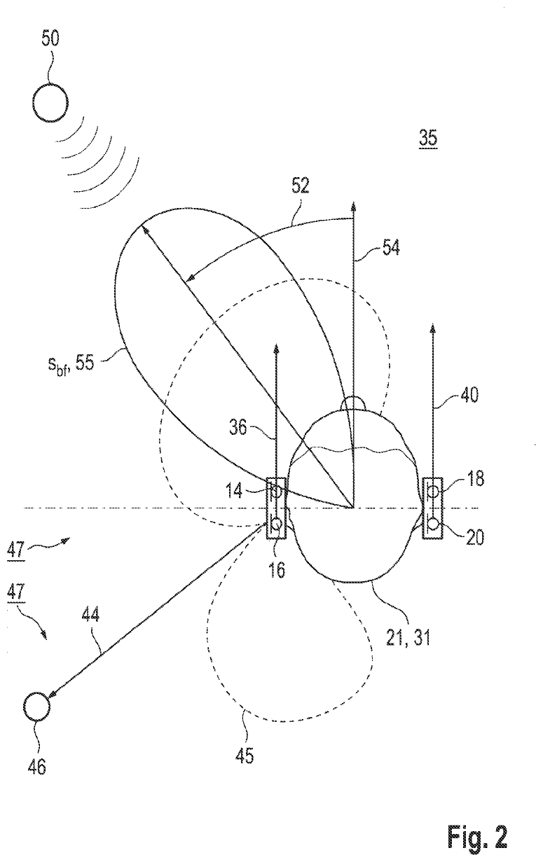

In FIG. 2, a schematic top view shows the location of the user 21 wearing the binaural hearing system 2 of FIG. 1, and other sound sources in an environment 35. The first hearing device 6 has a first frontal direction 36, as a direction of preference for its microphones, i.e., for the first reference microphone 14 and the first auxiliar microphone 16. The first frontal direction 36 is defined as the direction from the first auxiliary microphone 16 to the first reference microphone 14. The second hearing device 8 has a second frontal direction 40 as a direction of preference for its microphones, i.e., for the second reference microphone 18 and the second auxiliary microphone 20. The second frontal direction 40 is defined as the direction from the second auxiliary microphone 20 to the second reference microphone 18.

Depending on the specific design of the first and second hearing device 6, 8 and on the resulting positions on the head 31 of the user 21, the first and second frontal directions 36, 40 may coincide (i.e., the respective vectors if the first and second frontal direction 36, 40 may be parallel); however, it is also possible that due to design and construction of the binaural hearing system 2, the first and second direction 36, 40 are different.

The direction-sensitive pre-processing 24 on the first reference signal s₁ᵣ and the first auxiliary signal s₁ₐ, as shown in FIG. 1, is done in an adaptive way, i.e., the first null direction 44 tracks the source 46 in the back hemisphere 47 (delimited by the dotted line). A corresponding directional characteristic 45 for the resulting first pre-processed signal sp₁ is shown (dashed lines). In an analogous way, the direction-sensitive pre-processing 28 of FIG. 1 on the second reference signal s₂ᵣ and the second auxiliary signal s₂ₐ for generating the second pre-processed signal sp₂ may either be fixed, in particular giving a fixed second null direction (not shown), or adaptive with respect to an interferer. Preferably, the first and second pre-processed signal sp1, sp2 are both generated by adaptive direction-sensitive pre-processing 24, 28. In the latter case, due to shadowing effects of the head 31 and also of the ears, the direction-sensitive pre-processing 28 of the second hearing device 8 may adapt to a different interferer than the direction-sensitive pre-processing 24 of the first hearing device 6.

The direction-sensitive signal processing task to be performed by the binaural hearing system 2 according to FIG. 1 may be given by the localization of a dominant sound source 50 in the environment 35 of the binaural hearing system 12, i.e., by finding an angular source direction 52 for the sound source 50 with respect to a global direction of preference 54 for the binaural hearing system 2, said global direction of preference being derived from the first and second frontal directions 36, 40 (e.g., as the angular mean direction). Said task may also be given by generating a first beamformer output signal, preferably pointing towards the dominant sound source 50, to be converted into an output sound by an output transducer of the first hearing device 6. In FIG. 2, the first beamformer output signal is represented by the main lobe of its respective directional characteristic 55 (solid line).

In an analogous way, a direction-sensitive signal processing task may be performed in the second hearing device 8, based on the (local) second pre-processed signal sp₂, and on the (remote) first pre-processed signal sp1 that has been transmitted from the first hearing device 6 to the second hearing device 8 for performing said task.

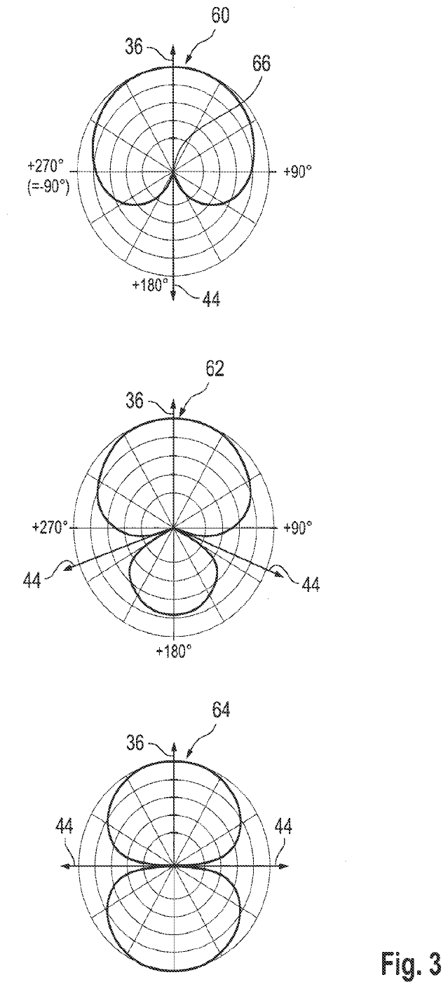

In FIG. 3, polar plot diagrams of directional characteristics 60, 62, 64 for the first (and possibly second) pre-processed signal sp₁ (respectively, sp₂) of FIG. 1 are shown. The directional characteristics 60, 62, 64 represent the sensitivity of the first pre-processed signal sp₁, as generated from the first reference signal sir and the first auxiliary signal s₁ₐ by the respective direction-sensitive pre-processing, with respect to a probe sound signal when varying the angular direction of a corresponding probe sound source (not shown) with respect to the origin 66. Note the indicated directions of +90°, +180° and +270°=−90° in the upper and the middle diagram for reference of conventions. Said origin 66 of the polar plots may, for example, be the center of the first reference microphone 14 and the first auxiliary microphone. For practical applications, the dimensions of the first hearing device 6 may be assumed to be small compared to the distance to said probe sound source (or other sound sources in a realistic scenario), such that the origin 66 may be approximated by a point position of the first hearing device 6 with respect to the position of another sound source.

Note that the directional characteristics 60, 62, 64 represent the sensitivity of the first local beamformer 26 without the hearing device 6 being mounted on the head 31 of the user 21, i.e., without any head shadowing effects or the like, but only the spatial sensitivity of the microphone array consisting of the two microphones 14, 16. The first pre-processed signal sp₁ then can be obtained by means of a first reference pre-processing coefficient w₁ᵣ and a first auxiliary pre-processing coefficient w₁ₐ for the respective first reference and auxiliary signals s₁ᵣₐ, s₁ₐ, as sp₁=w₁ᵣs₁ᵣ+w₁ₐs₁ₐ.

In the upper diagram, the first pre-processed signal sp₁ has a cardioid-shaped directional characteristic 60 with a null direction 44 at 180° with respect to the first frontal direction 36. The cardioid-shaped directional characteristic 60 in a free field for the first pre-processed signal sp₁ then can be obtained by setting (up to a global phase and a global gain, possibly accounting for a high-pass behavior of the cardioid) w₁ᵣ=1 and w₁ₐ=−e^{iωT} in the time-frequency domain, where T is the acoustic runtime difference between the first reference microphone 14 and the first auxiliary microphone 16 (a suitable global gain and phase factor for w₁ᵣ and w₁ₐ may be given by 1/(1−e^{-2iωT}) for cardioid-shaped directional characteristics). In the bottom diagram, the first pre-processed signal sp₁ has a figure-of-eight-shaped directional characteristic 64 with two null directions 44 at ±90° with respect to the first frontal direction 36. The figure-of-eight-shaped directional characteristic 64 can be obtained by setting (up to a global phase and a global gain, which in this case may be given by (1+e^{-ωT})/(1−e^{-2iωT})) w₁ᵣ=1, w₁ₐ=−1, as an example.

In the middle diagram, the first pre-processed signal sp₁ has a hypercardioid-shaped directional characteristic 62 with two null directions 44 at approx. ±110° with respect to the first frontal direction 36. The hypercardioid-shaped directional characteristic 62 can be obtained by a linear combination of the respective first reference and auxiliary pre-processing coefficients w₁ᵣ, w₁ₐ for the cases of the cardioid-shaped directional characteristic 60 and the figure-of-eight-shaped directional characteristic 64.

Note that FIG. 3 shows only particular cases for the first pre-processed signal sp₁, and the null directions 44 a priori may enclose any angle with the first frontal direction 36, even angles less than ±90° (i.e., a null direction may also point towards the frontal hemisphere).

Note that when the binaural hearing system 2 is mounted on the head 31 of the user 21, the second pre-processed signal sp₂ which preferably has similar properties as the first pre-processed signal, in particular may have different null directions resulting from an adaptation to a different sound source due to possible head shadowing effects. Thus, for a direction-sensitive signal processing task, such as binaural beamforming or source localization, which uses both the first and the second pre-processed signal sp₁, sp₂, two signals with possibly sharp differences in their directional characteristics are to be combined.

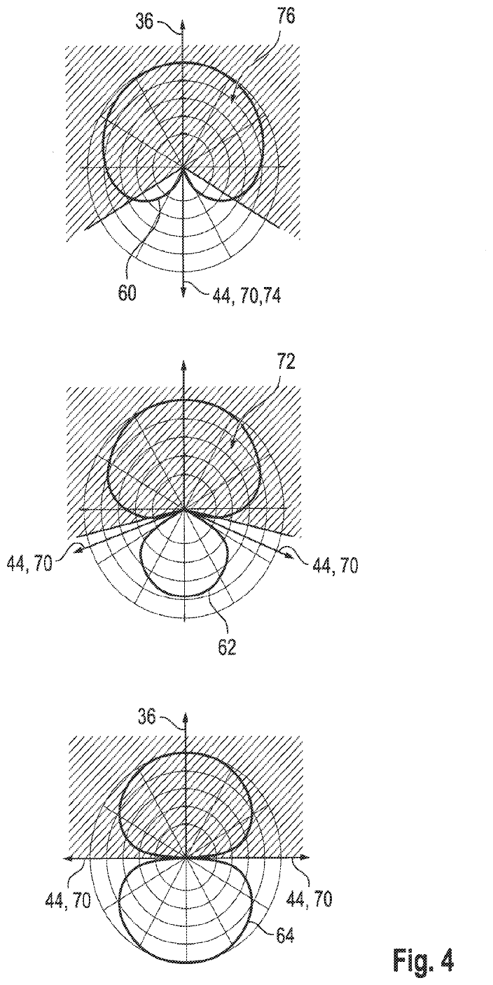

Therefore, in order to use the first pre-processed signal sp₁ for said binaural signal processing task in combination with the second pre-processed signal sp₂, the angular range for the null direction 44, i.e., for the direction of maximal attenuation 70 may be restricted, as shown in FIG. 4, where the shaded areas indicate forbidden angles for the directions of maximal attenuation 70.

In particular, the direction of maximal attenuation 70 may be restricted to a range of [+90°, +270°] with respect to the first frontal direction 36, as it is shown in the lower polar plot diagram, depicting the figure-of-eight-shaped directional characteristic 64 of FIG. 3. As a result, the direction of maximal attenuation 70 can still point towards ±90° (sufficient for generating the figure-of-eight-shaped directional characteristic 64), but not much more forward.

A further restriction is displayed in the middle polar plot diagram of FIG. 4; here, the direction of maximal attenuation 70 may be restricted to a range of [+105°, +255°] with respect to the first frontal direction 36. Note that with this restriction, a lateral interferer at +90° or −90° (=+270°) would not be fully attenuated anymore, as it is the case for the figure-of-eight-shaped directional characteristic 64. In the middle polar plot diagram, the hypercardioid-shaped directional characteristic 62 of FIG. 3 is depicted, which would still be achievable within the restrictions of the prohibited zone 72.

A yet further restriction is displayed in the upper polar plot diagram of FIG. 4, which depicts the cardioid-shaped directional characteristic 60 of FIG. 3; here, the direction of maximal attenuation 70 may be restricted to a range of [+125°, +235°] with respect to the first frontal direction 36. In this case, only an interferer in this angular range, i.e., in a cone of ±55° around the backward direction 74 would be fully attenuated by the first pre-processed signal sp₁. In case the interferer is outside the forbidden zone 76, the direction of maximal attenuation 70 would coincide with one of the two borders of the forbidden zone 76. In the present case, as the direction of maximal attenuation 70 is a null direction 44 in the backward direction 74, this implies a situation with an interferer at 180° with respect to the first frontal direction 36.

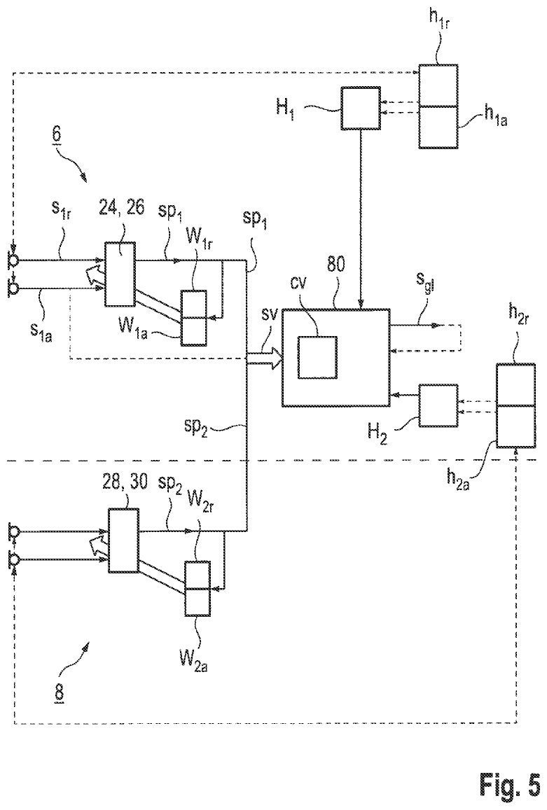

In FIG. 5, a block diagram of the signal flow of a method for operating the hearing system 1 according to FIG. 1 in the environment 35 according to FIG. 2 is shown. For the direction-sensitive pre-processing 24, the first reference pre-processing coefficient w₁ᵣ and the first auxiliary pre-processing coefficient w₁ₐ are provided by the adaptive first local beamformer 26, and for the direction-sensitive pre-processing 28, a second reference pre-processing coefficient w₂ᵣ and a second auxiliary pre-processing coefficient w₂ₐ are provided by the adaptive second local beamformer 30. Said first and second reference and auxiliary pre-processing coefficients w₁ᵣ, w₁ₐ, w₂ᵣ, w₂ₐ are adaptive, as mentioned above, and thus depend on the respective first or second reference and auxiliary signals s₁ᵣₐ, s₁ₐ or s₂ᵣ, s₂ₐ, respectively. The first pre-processed signal sp₁ is then generated as a linear combination of the first reference and auxiliary signal s₁ᵣ, s₁ₐ, weighted by the adaptive first reference and auxiliary pre-processing coefficients w₁ᵣ, w₁ₐ, i.e., sp₁=w₁ᵣs₁ᵣ+w₁ₐs₁ₐ, while the second pre-processed signal sp₂ is given by sp₂=w₂ᵣs₂ᵣ+w₂ₐs₂ₐ, in an analogous way. All involved signals and coefficients are frequency dependent (the frequency dependence has been suppressed here for the sake of simplicity). The first and the second pre-processed signal sp₁, sp₂, are generated by the first and second local beamformers 26, 30, according to restrictions on their directions of maximal attenuation 70, as described in FIG. 4.

Now, in order to perform the direction-sensitive signal processing task by means of the first and second pre-processed signal sp₁, sp₂ in the first hearing device 6, said task being, e.g., a source localization or the generation of a global beamformer signal, a first head-related transfer function H₁ and a second head-related transfer function H₂ are provided in a way yet to be described. The first and second head-related transfer function H₁ (ω, θ), H₂ (ω, θ) are intrinsically frequency-dependent (hence, the variable ω), and represent the propagation of a sound signal from a given angle θ towards the first and second hearing device 6, 8, respectively, taking into account head shadowing effects and the positions of the microphones of the respective hearing device 6, 8 with respect to the head 31 and the ear (in particular, the ipsilateral pinna) of the user 21. Due to this information on the propagation of sound in the direct vicinity of the head 31 of the user 21, the first and second head-related transfer function H₁ (ω, θ), H₂ (ω, θ) will be used for the direction-sensitive signal processing task, as well as the locally pre-processed signals sp₁, sp₂.

The first head-related transfer function H₁ may be given by either of the respective frequency- and angle-dependent first reference and auxiliary head-related transfer functions h₁ᵣ, h₁ₐ, which may be provided for the first reference microphone 14 or the first auxiliary microphone 16, wherein said first reference or auxiliary head-related transfer functions h₁ᵣ, h₁ₐ take into account the head (and possibly pinna) shadow effects for sound that propagates from the angle θ with respect to the global direction of preference 54 towards the corresponding microphone position on or at the left side 32 of the head 31 of the user 21. In a similar way, the second head-related transfer function H₂ may be given by either of the respective second reference and auxiliary head-related transfer functions h₂ᵣ, h₂ₐ, which may be provided for the second reference microphone 18 or the first auxiliary microphone 20.

Now, a direction-sensitive signal processing task 80 is performed on the first pre-processed signal sp₁ and the second pre-processed signal sp₂, wherein for performing said task 80 locally in the first device 6, the second pre-processed signal sp₂ is transmitted to the first device 6 (indicated in FIG. 3 by the domain enclosed by the dashed line). The second head-related transfer function H₂ may be stored beforehand in an appropriate memory of the first hearing device 6.

The task 80 may be given by any directional processing that involves the first and second pre-process signal sp₁, sp₂, as well as the first and second head-related transfer function H₁, H₂. In particular, during as a result of the task 60, and/or during an intermediate step (dashed feedback loop), a globally-processed signal s_{gl} may be generated as

s_{gl}(ω,θ₀)=c₁(ω,θ₀,H₁,H₂)sp₁(ω)+c₂(ω,θ₀,H₁,H₂)sp₂(ω) (i)

wherein c₁ and c₂ represent frequency-dependent coefficients for the generation of the globally-processed signal s_{bf} which, in general, both also depend on the first and second head-related transfer function H₁, H₂, as well as on a spatial direction θ₀ with respect to which a specific signal processing task is performed.

Among other examples, the globally-processed signal s_{gl} may be given by a binaural beamformer signal (pointing towards the direction of preference θ₀) or by a so-called notch-filtered signal sₙ which shows a maximal (and ideally total) attenuation towards the direction θ₀. A suitable set of such notch-filtered signals sₙ may be used for determining the location of a sound source, by scanning the total space with the notch-filtered signals sₙ (and varying the notch angle θ₀ for said scan).

Generally, the globally-processed signal s_{gl} can be represented as a scalar product of a signal vector sv=[sp₁, sp₂]^{T} containing the two pre-processed signals sp₁, sp₂ and a coefficient vector cv=[c₁, c₂]^{T} containing the coefficients c₁(ω, θ₀, H₁, H₂) and c₂(ω, θ₀, H₁, H₂), i.e.,

s_{gl}=cv^{H}·sv=c₁sp₁+c₂sp₂ (ii)

in the case that the task 80 is using only the two pre-processed signals sp₁, sp₂ as the only input signals. However, the task 80 may also involve one or more further signals, e.g., the first reference signal sir and/or the first auxiliary signal s₁ₐ (c.f. dotted arrow from the first auxiliary signal s₁ₐ towards the signal vector sv), and/or also another locally pre-processed signal, preferably generated in an analogous way as the first and second pre-processed signal sp₁ and sp₂. In such a case of more than two signals for the task 80, the signal vector sv has three (or four or more) components, and the coefficient vector cv is to be constructed accordingly to match the dimension of sv. For the first auxiliary signal s₁ₐ, e.g., a corresponding dependence on h₁ₐ (not shown) can be implemented in the coefficients c₁, c₂, c₃ (and possibly further coefficients). For another locally pre-processed signal sp3, a corresponding head-related transfer function H₃ is to be implemented into the coefficients c₁, c₂ and c₃.

The task 80, e.g., may be given by a generation of the binaural beamformer signal s_{bf} pointing towards a specific direction θ₀. In this case, the respective signal contribution of the first and second pre-processed signal sp₁, sp₂ also has to be filtered with respective filter coefficients c₁ and c₂ (as given above in equation ii) involving the corresponding first or second head-related transfer function H₁, H₂, in order to properly account for the head shadowing effects of sound originating from the direction θ₀ towards which the beamformer signal s_{bf} shall be directed.

However, the direction-sensitive signal processing task 60 may also be given by the localization of an a priori unknown angle θ₀ of a sound source (taken with respect to a global direction of preference such as a frontal direction of the hearing system 1).

To this end, a set of angle-dependent spatial filters F(θ) is formed by coefficient vectors cv(θ) as given above from the first and second head-related transfer function H₁, H₂. Each of said spatial filters F(θ) effectively forms a notch in the direction θ corresponding to the argument, and scanning the entire space surrounding the user 21 of the hearing device 1 by incrementing the angle argument θ of the filters F(θ) (e.g., by 10° or 15° or 20° in each incremental step). Then, each of the spatial filters F(θ) is applied as its respective coefficient vector cv (c.f. above) to the signal vector sv=[sp₁, sp₂]^{T}, i.e., to the first and second pre-processed signal. The angle θ₀ of the sound source of interest then corresponds to the spatial filter F (θ₀) with the minimum signal energy of the filtered signal vector, i.e., to the spatial filter which blocks most of the signal energy out of the first and second pre-processed signal sp₁, sp₂.

Then, the spatial filters F(θ) may be derived by imposing additional constraints on the gain, e.g., in frontal direction (0°). The spatial filter F(θ) can then be described by

F(θ)=M(M^{H}M)⁻¹g*,

where the gain constraint vector g and the normalized constraint coefficient matrix M may be given by

$$g = [ \begin{matrix}{g}_{0} \\ {g}_{θ}\end{matrix} ] , M = [ \begin{matrix}{H}_{1} ( 0 ° ) / {H}_{1} ( 0 ° ) & {H}_{1} ( θ ) / {H}_{1} ( θ ) \\ {H}_{2} ( 0 ° ) / {H}_{1} ( 0 ° ) & {H}_{2} ( θ ) / {H}_{1} ( θ )\end{matrix} ] = [ \begin{matrix}1 & 1 \\ {H}_{21} ( 0 ° ) & {H}_{21} ( θ )\end{matrix} ]$$

with the normalized gain constraints g₀, g_{θ} representing the gain at 0° and at the angle θ, respectively (e.g., g₀=1, g_{θ}=0), and H₂₁(0°) being the quotient H₂ (0°)/H₁(0°) (and likewise for θ, wherein the frequency dependence of H₁, H₂ has been omitted). In case that three or more signals are used for the task 80, the gain constraint vector g is a three or more component vector, wherein for each spatial filter F(θ), the total number of constraints shall match the total number of local and/or locally pre-processed signals used for the implementation of the task 80.

The designed spatial filter F(θ) is applied to the signal vector sv=[sp₁, sp₂]^{T} as the scalar product F^{H}(θ)·sv. In this example, the spatial filter F(θ) is designed to have maximum attenuation at a source angle θ₀ and distortion-less response at the frontal source direction (0°) based on the gain constraints g_{θ} and g₀, respectively.

The angle θ₀ of a dominant sound source can then be determined, at least as an approximation, by the angle θ for which the corresponding spatial filter F(θ) applied to the signal vector sv=[sp₁, sp₂]^{T} as the scalar product F^{H}(θ)·sv, i.e., the globally-processed signal s_{gl} for each of the angles θ, minimizes the total energy.

The restrictions on the direction of maximal attenuation 70 of the first and second pre-processed signal sp₁, sp₂, as shown in FIG. 4, help to reduce spatial distortion that might stem from the use of the first reference or auxiliary head-related transfer function h₁ᵣ, h₁ₐ as the first head-related transfer function H₁ (see corresponding dashed arrows), and the second reference or auxiliary head-related transfer function h₂ᵣ, h₂ₐ as the second head-related transfer function H₂ (see corresponding dashed arrows), in combination with the local pre-processing by the first and second local beamformers 26, 30. Note that this spatial distortion, which could compromise the final result of the task 80, cannot simply be avoided by another global choice for the first and second head-related transfer functions H₁, H₂, as the inaccuracies stem from the interplay of these functions with the adaptively generated pre-processed signals sp₁, sp₂. Thus, restricting the beamforming for the local pre-processing might compromise the local pre-processing (and may lead to a sub-optimal improvement of the sound quality, e.g., in terms of signal-to-noise ratio, SNR), but can then improve the overall performance—also in terms of possible SNR—due to the increased spatial accuracy.

Even though the invention has been illustrated and described in detail with help of a preferred embodiment example, the invention is not restricted by this example. Other variations can be derived by a person skilled in the art without leaving the extent of protection of this invention.

The following is a summary list of reference numerals and the corresponding structure used in the above description of the invention:
1 hearing system
2 binaural hearing system
6 first hearing device
8 second hearing device
14 first reference microphone
16 first auxiliary microphone
18 second reference microphone
20 second auxiliary microphone
22 environment sound
24 direction-sensitive pre-processing
26 first local beamformer
28 direction-sensitive pre-processing
30 first local beamformer
32 left side
34 right side
36 first frontal direction
40 second frontal direction
44 first null direction
45 directional characteristic
46 interferer
47 directional characteristic
50 (dominant) sound source
52 angular source direction
54 global direction of preference
55 directional characteristic
60 cardioid-shaped directional characteristic
62 hypercardioid-shaped directional characteristic
64 figure-of-eight-shaped directional characteristic
66 origin
70 direction of maximal attenuation
72 forbidden zone
74 backward direction
76 forbidden zone
80 direction-sensitive signal processing task
cv coefficient vector
F spatial filter
g gain constraints
h₁ᵣ first reference head-related transfer function
h₁ₐ first auxiliary head-related transfer function
h₂ᵣ second reference head-related transfer function
h₂ₐ second auxiliary head-related transfer function
H₁ first head-related transfer function
H₂ second head-related transfer function
s₁ᵣ first reference signal
s₁ᵣ first auxiliary signal
s₂ᵣ second reference signal
s₂ₐ second auxiliary signal
sp₁ first pre-processed signal
sp₂ second pre-processed signal
sv signal vector
w₁ᵣ first reference pre-processing coefficient
w₁ₐ first auxiliary pre-processing coefficient
w₂ᵣ second reference pre-processing coefficient
w₂ₐ second auxiliary pre-processing coefficient

1. A method of operating a hearing system, the hearing system including a first hearing device and a second hearing device, the first hearing device having a first reference microphone and a first auxiliary microphone, and the second hearing device having a number of microphones, the method comprising:
for the first hearing device:
generating a first reference signal and a first auxiliary signal from an ambient sound by the first reference microphone and the first auxiliary microphone, respectively;
defining a first frontal direction as a direction from the first auxiliary microphone towards the first reference microphone; and
generating a first pre-processed signal by applying a direction-sensitive pre-processing to the first reference signal and the auxiliary signal by way of corresponding first reference and first auxiliary pre-processing coefficients, respectively, to be chosen and applied to the first reference signal and the first auxiliary signal accordingly in such a way that the first pre-processed signal shows a maximal attenuation for a generic sound signal originating from an angle that is restricted to an angular range of [+90°, +270°] with respect to the first frontal direction;
providing a first head-related transfer function that is representative of a propagation of a generic sound signal from a given angle towards the first hearing device when the first hearing device is mounted on a head of a user;
for the second hearing device:
generating a second pre-processed signal by way of the number of microphones, the second pre-processed signal being representative of the ambient sound; and
providing a second position-related transfer function, representative of the propagation of the generic sound signal from a given angle towards the second hearing device when the second hearing device is mounted at a specific location; and
performing a direction-sensitive signal processing task on the first pre-processed signal and the second pre-processed signal, using the first head-related transfer function and the second position-related transfer function; and
generating the first pre-processed signal by way of an adaptive beamforming process employing the first reference and first auxiliary pre-processing coefficients.

2. The method according to claim 1, wherein the number of microphones of the second hearing device includes at least a second reference microphone and a second auxiliary microphone, and the method further comprises:
for the second hearing device:
generating a second reference signal and a second auxiliary signal from the ambient sound by the second reference microphone and the second auxiliary microphone, respectively;
defining a second frontal direction as the direction from the second auxiliary microphone towards the second reference microphone; and
generating the second pre-processed signal by applying a direction-sensitive pre-processing to the second reference signal and the second auxiliary signal by way of corresponding second reference and second auxiliary pre-processing coefficients, respectively, to be chosen and applied to the second reference signal and the second auxiliary signal accordingly in such a way that the second pre-processed signal shows a maximal attenuation for a generic sound signal originating from an angle that is restricted to an angular range of [+90°, +270°] with respect to the second frontal direction.

3. The method according to claim 2, which comprises providing as the second position-related transfer function, a second head-related transfer function, the second head-related transfer function being representative of a generic sound signal from a given angle towards the second hearing device when the second hearing device is mounted on the head of the user, with the first and second hearing devices being mounted on mutually opposite sides of the head.

4. The method according to claim 1, wherein the direction-sensitive signal processing task comprises at least one of determining an angle of a sound source or generating a beamformer signal, with the beamformer signal containing signal contributions from the first and second pre-processed signals.

5. The method according to claim 3, wherein the direction-sensitive signal processing task comprises determining an angle of a sound source by generating a set of spatial filters with the first and second head-related transfer functions, each of the spatial filters forming an attenuation notch in space towards a different angle.

6. The method according claim 1, which comprises generating the first pre-processed signal by applying the direction-sensitive pre-processing in such a way that the first pre-processed signal shows a maximal attenuation for a generic sound signal originating from an angle that is restricted to an angular range of [+125°, +235°] with respect to the first frontal direction.

7. The method according to claim 1, which comprises generating the first pre-processed signal to have a directional characteristic with a cardioid shape or a figure-of-eight shape, or any convex combination of a cardioid shape and a figure-of-eight shape.

8. The method according to claim 1, which comprises, as the first head-related transfer function, providing a first reference head-related transfer function or a first auxiliary head-related transfer function, being representative of the propagation of a generic sound signal from a given angle towards the first reference microphone or towards the first auxiliary microphone, respectively, when located at a respective position on the head of the user.

9. A hearing system, comprising:
a first hearing device having a first reference microphone and a first auxiliary microphone;
a second hearing device having a number of microphones;
a control unit having at least one signal processor, and wherein the hearing system is configured to perform the method according to claim 1.

10. The hearing system according to claim 9, configured as a binaural hearing system, with:
said first hearing device and said second hearing device being configured to be worn by a user on mutually different ears during an operation of the binaural hearing system.
